(19) United States
(12) Patent Application Publication
(10) Pub. No.: US 2001/0050616 A1
(43) Pub. Date: Dec. 13, 2001

(54) SECURITY AND GARMENT LABEL

(76) Inventor: JOHN CHARLES LOWE, COVINGTON (GB)

Correspondence Address: HAUGEN LAW FIRM PLLP, 121 SOUTH EIGHTH STREET STE 1130, MINNEAPOLIS, MN, 55402

(21) Appl. No.: 09/397,297

(22) Filed: Sep. 15, 1999

(30) Foreign Application Priority Data
Jan. 23, 1999 (GB) 9901467.2
Jul. 22, 1999 (GB) 9917054.0

(51) Int. Cl. G08B 13/14

(52) U.S. Cl. 340/572.1; 340/540

(57) ABSTRACT

A security label for incorporation within a garment, the label comprising first and second layers of flexible material secured in face to face contact with one another, said second layer comprising a planar security tag and said first layer serving as a support therefor.

This invention relates to a combined security and garment label.

More particularly, but not exclusively, this invention relates to an integrated security device and woven label.

It is known to provide clothing, as sold in high street stores, with security devices to deter thieves and activate alarms during the theft of an article.

Such items include plastics clips which may only be removed by a tool at the cashiers' desk. Such devices tend to be bulky and inhibit attractive display of the products.

It is also difficult to attach such clips to bulky clothing and correspondingly difficult to remove them. Such clips may also damage fragile materials as they inherently require an attachment device based on a piercing tool.

An object of this invention is to provide an improved security device which also attempts to alleviate the aforementioned problems.

According to an aspect of the invention there is provided a combined security and garment label, the label comprising a layer of flexible material suitable for providing information, and a second layer of flexible material comprising a security device.

According to one aspect of the invention, the combined security and garment label comprises a security label positioned between two layers of the garment label. The layers of the garment label comprise a front layer and a backing layer.

Preferably in one embodiment of the invention one side of a first layer of the garment label is provided with adhesive. The security tag is positioned on the adhesive. The second layer of said garment label is adhered to the adhesive coated side of said first layer such that the security tag is enveloped between the two layers.

In another embodiment of the invention, the garment label comprises one layer only. The security tag is adhered to the back side of said garment label so as to form a combined security and garment label.

At least one embodiment of the invention will now be described with reference to the accompanying drawings, in which:

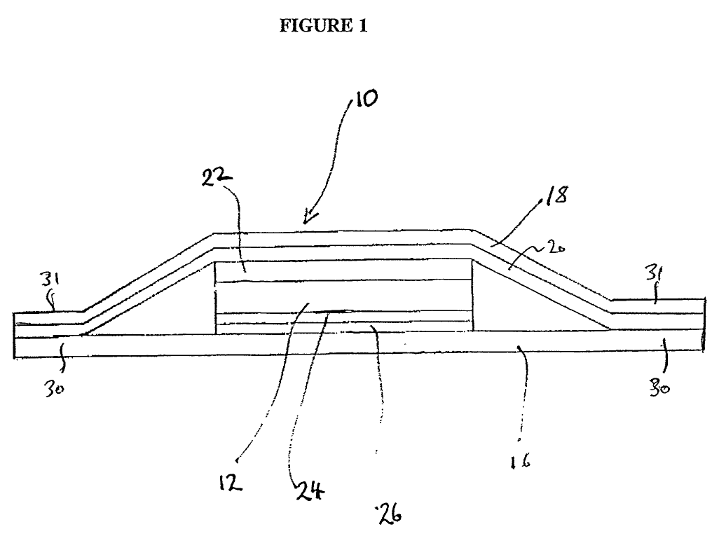

FIG. 1 is a section view of a security label according to one embodiment of the invention;

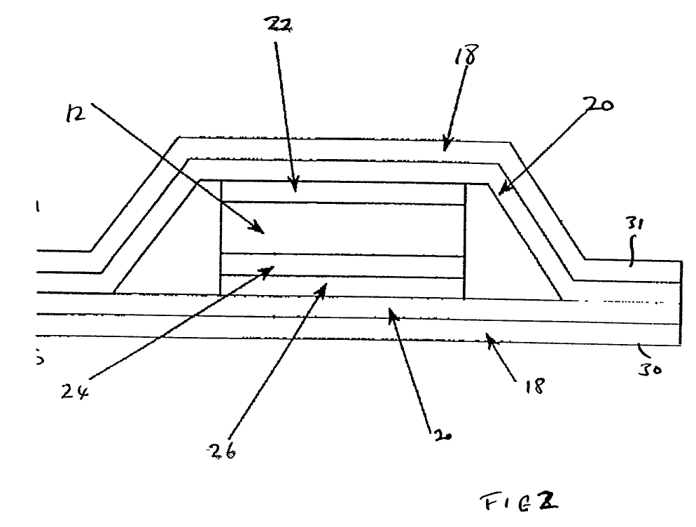

FIG. 2 is a side view of a security label according to a further embodiment of the invention;

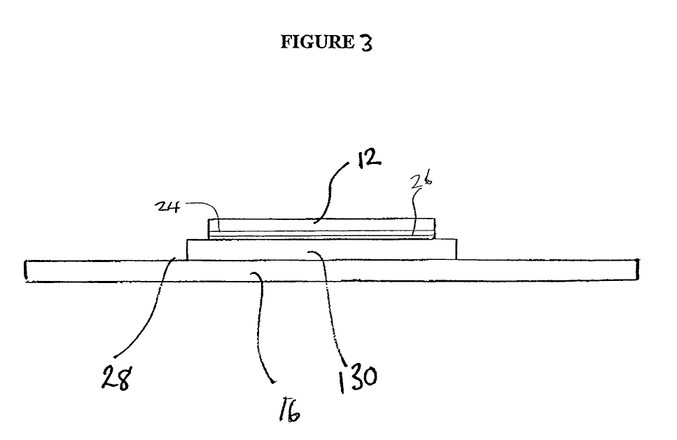

FIG. 3 is a side view of a security label according to a further embodiment of the invention;

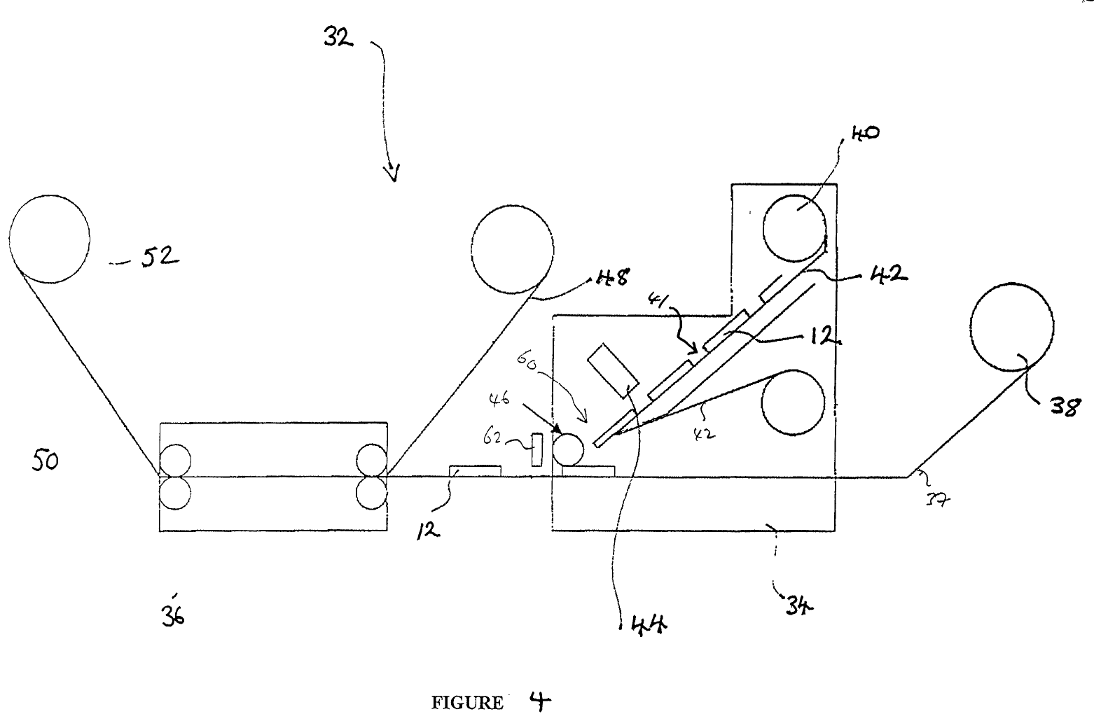

FIG. 4 is a schematic view of apparatus suitable for manufacturing the security label of FIGS. 1 and 2;

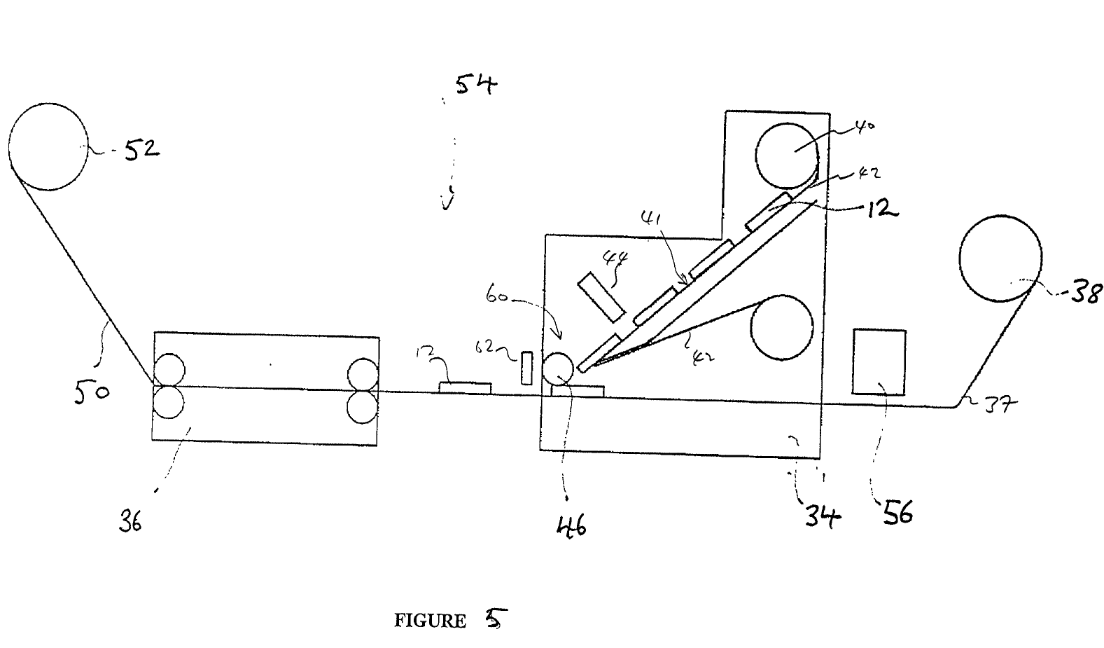

FIG. 5 is another schematic view of apparatus suitable for manufacturing the combined security and garment label of FIG. 3.

Referring initially to FIG. 1 a security label is shown generally at 10. A security tag 12 is sandwiched between two layers of the label 10. The security tag 12 is planar, relatively flexible, and itself defines a layer of the security label 10. The security tag 12 is preferably a RF (Radio Frequency) device of the type which is capable of being de-activated by authorised personnel; suitable devices of this type are disclosed, for example, in U.S. Pat. No. 5,006,856. It will be appreciated that other known types of planar security devices which perform a similar purpose may be used, e.g. magnetic strips. The security label of FIG. 1 comprises two flexible layers 16, 18, both of which are preferably textile fabrics.

When being used as a garment label, layer 16 (which may be referred to as the top layer) constitutes the main body of the label and as shown is preferably flat, i.e. it extends rectilinearly along its entire length and thereby defines a planar support for the security tag 12. Also, the top layer 16, may be provided with indicia normally indicating the manufacturer, owner or composition of the garment to which it is to be attached. The second layer 18 may be generally referred to as a backing layer. When the security label is to be used as a garment label, the top layer 16 is preferably a woven material and the backing layer is preferably a lightweight flexible textile material, such as a non-woven fabric. The flexibility of the backing layer 18 and security tag 12 is preferably such that the tag 12 and layer 18 do not appreciably stiffen the top layer 16 and so do not detract from its functionality of being a garment label.

A suitable adhesive 20, preferably a heat curable adhesive, is applied to the underside of backing layer 18. The security tag 12 is also coated on both sides with a heat curable adhesive 22,24 suitable for use with adhesive 20. In addition, an additional outer layer of adhesive 26 is provided on adhesive layer 24; adhesive 26 being pressure sensitive in order to enable tag 12 to be initially adhered to top layer 16 (as described in more detail below) The adhesive 26 only covers a limited surface area of the tag 12 so as not to interfere with bonding between adhesive 24 and the surface of layer 16. Preferably adhesive 26 is formed into two or more strips.

The backing layer 18 and top layer 16 have marginal regions 30,31 respectively which extend beyond and around the periphery of the tag 12. The marginal regions 30,31 are bonded to one another, preferably by adhesive 20, so as to envelop the security tag continuously around its periphery. This ensures that the tag does not move, in use, relative to layers 16,18 and/or ensures that the tag 12 is always retained internally of the label 10. Accordingly the product may withstand domestic washing and/or commercial dry cleaning processes whilst maintaining its integrity. The security label 10 of the invention can, therefore, be attached to an item of clothing, for example, and remain with the garment for the life of the garment without detriment to the garment. For example, since the security tag 12 is enveloped by both layers 16, 18 it is not likely to mark or stain the garment during its life, nor is the tag 12 likely to emerge from between layers 16,18.

Preferably adhesive 22, 24 is a polyester adhesive and adhesive 26 is an acrylic pressure sensitive adhesive.

Instead of acting as a garment label, it is envisaged that the security label 10 of the present invention may be incorporated within a garment so as to be concealed; for example it may be incorporated during manufacture of the garment between the garment outer fabric and inner lining. In such a case, it is envisaged that top layer 16 may be a light weight flexible material, such as a nonwoven fabric. Conveniently, as shown in FIG.

Another example of a security label according to the invention is illustrated in FIG. 3. In this aspect of the invention the security tag 12 is applied to one side 28 of the top layer 16 only, ie. the lower layer is dispensed with so that the tag 12 is secured to a single support layer. If the security label defines a garment label, then preferably the support layer comprises layer 16 which is preferably a woven fabric. Thus, the adhesive 24 which is used is suitable for adhering the security tag material eg. metal, to woven cloth material.

Preferably an additional layer 130 of heat curable adhesive is provided on the layer 16 which is capable of bonding with adhesive 24. Layer 130 may extend beyond the outer periphery of the tag 12 to ensure that the tag 12 is embedded across its entire lower surface in adhesive.

Preferably the heat adhesive 20, 22, 24 and 30 is a diamide adhesive. For example for security tags supplied from Checkpoint Systems Inc., the adhesive 22, 24 is diamide 2401.

Now referring to FIG. 4, apparatus for producing a security label 10 is shown generally at 32. Two main machines are utilised in this process, a label applicator machine 34 and a laminating and curing machine 36.

A strip 37 of garment labels is supplied to the label applicator machine 34 from a roll 38. Also, a strip 41 of security tags 12 is supplied to applicator machine 34 from a roll 40. The tags 12 each have upper and lower layers of adhesive 22,24 and an outer lower layer of adhesive 26 which covers only a portion of the surface area of adhesive 24; and are carried by a release paper 42 which is in contact with adhesive layer 26.

The label applicator machine 34 feeds the security tags 12, located on release paper 42, intermittently to a tag application station 60. A sensor 44 is provided to detect the spaces between adjacent tags 12 and acts to hold successive tags 12 at the application station 60 until a garment label is positioned at the application station 60. A sensor 62 is provided to detect when a label is correctly positioned at the application station 60. This is preferably achieved by incorporating a marker on each label which is detectable by the sensor 62. When a label is located at the station 60, the next tag 12 is deposited onto that label. A pressure roller 46 applies pressure to the security tags 12 as they are positioned on the woven labels 14 and thereby causes adhesive 26 to bond with the label and hold the tag 12 in place.

The strip 37 of woven garment labels having the security tags 12 secured thereto is then fed into the laminating and curing machine 36. Heat and pressure is applied to the security tag 12 and garment label during application of a backing material 48 which is preferably a non-woven fabric. A non-woven fabric is preferred as a backing material since it is relatively inexpensive and does not act to stiffen the woven labels. The backing material 48 carries on one surface adhesive 20. This backing material 48 forms the backing layer 18 of the security label 10.

The heat and pressure melts the adhesive on the tag 12 and adhesive already located on the backing material 48 such that the backing material is bonded to the label 14 so as to envelop and locate the security tag 12.

The formed sheet 50 of security labels 10 is then collected on a take-up roll 52.

It is envisaged that the labels 10 may be further processed using standard cutting and folding machines to produce individual cut labels with sealed edges to prevent fraying. The heat and pressure involved in this process is such that it does not damage the label 10.

The apparatus shown in FIG. 4 may be used to produce the label shown in FIG. 2; to do this the strip 37 of garment labels is replaced by a strip of material for forming layer 18, the material being coated with adhesive 20.

Now referring to FIG. 5, machinery suitable for producing a security label 10 as shown in FIG. 3, is illustrated generally at 54.

Apparatus 54 is similar to apparatus 32, and similar parts have been designated by the same reference numerals.

The apparatus 54 again comprises two main machines 34, 36. The manufacturing process is similar to that described above, however, in this case, the step of providing backing material 48 is removed.

In addition, the security tags 12 are provided with heat curable adhesive 24 and pressure sensitive adhesive 26 on one side only, ie. heat curable adhesive 22 is not provided.

In the case where the strip 37 comprises garment labels, which are preferably woven, an adhesive applicator 56 is provided over the strip 37 of the woven garment labels to apply discrete areas of a heat activatable adhesive on each label prior to reaching the application station 60. The woven labels 14 are each provided with security tags 12 at station 60 and initially secured thereto by the pressure sensitive adhesive on the tag 12.

As with apparatus 32, the strip 37 of labels is pulled through the laminating and curing machine 36 where the adhesive is cured and the security tag 12 is bonded permanently to the label.

1. A security label for incorporation within a garment, the label comprising first and second layers of flexible material secured in face to face contact with one another, said second layer comprising a planar security tag and said first layer serving as a support therefor.

2. A label according to claim 1 wherein the first and second layers are secured in face to face contact by a heat curable adhesive.

3. A label according to claim 1 or 2 including a third layer, said first and third layers having marginal portions extending beyond the periphery of the second layer and being secured thereto around said periphery of the second layer.

4. A label according to claim 3 wherein said marginal portions of the first and third layers are bonded to one another by a heat curable adhesive.

5. A label according to claim 4 wherein said first layer extends in a rectilinear manner.

6. A label according to claim 3, 4 or 5 wherein said tag has heat curable adhesive on both faces prior to bonding with the first layer.

7. A label according to any of claims 3 to 6 wherein the face of said third layer facing the first layer carries a layer of heat curable adhesive prior to securance to said first layer.

8. A label according to any of claims 3 to 7 wherein said third layer comprises a non-woven textile fabric.

9. A label according to claim 8 wherein said first layer comprises a woven textile fabric, and said first layer preferably defines a garment label.

10. A label according to any of claims 3 to 8 wherein said first layer comprises a non-woven fabric.

11. A label according to claim 1 or 2 wherein the first layer is provided with a layer of heat curable adhesive prior to securance of the tag to the first layer.

12. A label according to claim 1, 2 or 11 wherein said first layer is a woven fabric and preferably defines a garment label.

13. A label according to claim 1, 2 or 11 wherein said first layer is a non-woven fabric.

14. A label substantially as herein described with reference to and as illustrated in FIGS. 1 to 3 of the accompanying drawings.

15. A method of producing a security label including the steps of feeding a strip of support material to a security tag application station, applying a tag to said strip and securing thereto by a pressure sensitive adhesive, and transporting the strip to a curing station wherein heat curable adhesive is cured to secure the tag to the support material.

16. A method of producing a security label substantially as herein described with reference to the accompanying drawings.
